(19) United States
(12) Patent Application Publication
(10) Pub. No.: US 2018/0338233 A1
(43) Pub. Date: Nov. 22, 2018

(54) METHOD FOR USING THRESHOLD VALUES FOR WIFI SIGNALS AND ASSOCIATED WIFI STATION

(71) Applicant: ORANGE, Paris (FR)

(72) Inventors: Laurent Cariou, Portland, OR (US); Imad Jamil, Cesson Sevigne (FR)

(21) Appl. No.: 15/504,143

(22) PCT Filed: Sep. 8, 2015
(86) PCT No.: PCT/FR2015/052382

§ 371 Date: Feb. 15, 2017

(30) Foreign Application Priority Data
Sep. 11, 2014 (FR) 1458554
Sep. 8, 2015 (FR) PCT/FR2015/052382

(51) Int. Cl. H04W 4/80; H04W 76/10

(52) U.S. Cl. CPC H04W 4/80; H04W 76/10

(57) ABSTRACT

The present invention relates to a method of using WiFi signal threshold values. The method comprises the steps consisting:
in making joint use of transmission power reduced by a first threshold value (delta_TPC) and of reception sensitivity threshold increased by a second threshold value (delta_CCA) in at least one WiFi station in a WiFi transmitter-and-receiver pair, with the sum of the threshold values (delta_TPC, delta_CCA) being bounded by a determined value.

The present invention relates to the field of telecommunications. Within this field, the invention relates more particularly to WiFi networks and to residential or public gateways including an access point to a WiFi network, and also to WiFi terminals.

A WiFi network makes use in particular of wireless transmission technology based on the IEEE 802.11 radio network standard and on extensions thereto commonly lumped together under the term “WiFi” (as in “wireless fidelity”). The latest extensions to the IEEE 802.11 standard seek to increase the density of WiFi terminals and of access points in a small area. Such a context requires appropriate mechanisms for serving clients fairly with a spectrum resource that is limited. In particular, in the 2.4 gigahertz (GHz) band, the WiFi spectrum is subdivided into twelve channels, only three of which are totally disjoint.

One function of a gateway is to establish an interface between a client terminal and a broadband network, usually a wired network, e.g. of the asymmetric digital subscriber line (ADSL) type for a private gateway. For this purpose, the gateway has at least one WiFi access point to the broadband network. A gateway also performs modem and router functions. The access point is set to one of the various WiFi channels in the band under consideration (2.4 GHz, 5 GHz, etc.).

Given that access to the WiFi channel is based on shared access, an access protocol is needed, and the most commonly used access protocol is the carrier sense multiple access/collision avoidance (CSMA/CA) protocol, as described in the 802.11-2007 standard in paragraph 9.1 “MAC architecture”, 9.1.1 “DCF” [1]. It operates as follows.

Each station, access point, or client terminal that has information for transmission competes for access to the channel during contention stages. The station listens to the channel during the contention stage. If no signal is detected during a predefined waiting time known as the “backoff” time, which is specific to each station, then the station can begin to transmit on the channel at the end of counting down its specific time.

That mechanism relies on the clear channel assessment (CCA) function, which, on each station, indicates whether the channel is busy or free. The CCA threshold corresponds to a power threshold. If the received signal is above this threshold, then the channel is busy, otherwise the channel is free. These thresholds are set by the 802.11 standard. At present, there are two types of threshold, one type for detecting energy only, and another type for detecting a WiFi signal (less than 20 decibels (dB) by detecting physical layer convergence protocol (PLOP) preambles in the physical layer).

The IEEE 802.11 standard has defined the CCA thresholds so that they are as low as possible in order to provide maximum protection for ongoing transmission. These CCA thresholds always have a value that is negative when expressed in dBm (decibels relative to one milliwatt).

Nevertheless, in environments that are very dense, such as in a stadium or in a congress hall, where adjacent cells using the same WiFi channel may be very close together, such a CCA threshold does not enable spectrum to be reused between a plurality of cells, even though the signals could be received correctly by their destination in the event of simultaneous transmission (since the minimum “signal to interference plus noise ratio” (SINR) for each link is large enough). Under such conditions of a very high density environment, it is found that only one radio link can be established with an access point, even though five to ten times as many simultaneous communications could be set up successfully.

In order to improve performance in such situations, and as shown in FIG. 1, the 802.11 standard defines both the transmit power control (TPC) mechanism and also the clear channel assessment control (CCAC) mechanism, also referred to as dynamic sensitivity control (DSC).

Transmit power control (TPC) adaptation consists in reducing the transmit power of all of the stations and access points (APs) in a given area. As a result, the protection area for each station is reduced and the level of co-channel interference (CCI) between the same channels belonging to different cells decreases. Consequently, this makes it possible to transmit simultaneously in cells that are adjacent to a given cell while using the same WiFi channel.

The TPC mechanism is conventionally used in cellular networks that operate with centralized organization. A base station serves all of the terminal clients in synchronized and ordered manner. That mechanism operates very well, but it is of benefit only to stations that neighbor stations implementing the TCP mechanism. For a station to benefit from the TCP mechanism, it suffices that the neighboring stations implement it. The mechanism is compatible with the WiFi standard and it can be used by WiFi stations. Nevertheless, given that it is of benefit only to stations neighboring those that implement the TCP mechanism, stations do not implement it.

In bands that are not licensed, such as those used in WiFi, it is common practice to search for a good level of aggressivity in accessing a channel. The TCP mechanism is not sufficiently aggressive since it is parties not implementing the solution that are favored.

The second mechanism or CCAC consists in increasing the CCA threshold for all of the stations and access points (APs) in a given area. The protection area is also reduced by this mechanism. This mechanism is better adapted than the TCP mechanism for a WiFi context since it generates the same effects as shown in FIGS. 2a and 2b, which plot data rate as a function of time. However this CCAC mechanism does indeed favor stations that implement the mechanism.

This improvement in the utilization of the spectrum resource in a high density context also needs to take account of the presence of so-called “legacy” stations. These stations are stations of older generations, i.e. stations that are compatible with a version of the WiFi standard that is earlier than the version standardizing the mechanism in use under consideration.

For the TPC mechanism, early generation stations (i.e. “legacy” devices) do not reduce their transmission power. They are thus more protected than “TPC” stations that are implementing the TCP mechanism. The presence of legacy stations in a given area eliminates the effect of spectrum reutilization. In an area in which both legacy stations and TPC stations are present simultaneously, the observed data rates are greatly reduced, as shown in FIG. 3a, which plots data rate as a function of time for a mixture of legacy stations and of stations implementing TPC.

For the CCAC mechanism, legacy stations do not reduce the data rates of stations implementing control of the CCA, nor do they reduce the reutilization of spectrum. The total data rate is thus very high, as shown in FIG. 3b, which plots data rate as a function of time for a mixture of legacy stations and of stations implementing CCA control. However, the legacy stations are then often in a “starvation” situation: they do not manage to access the channel, so they are greatly disadvantaged. There is therefore a problem of fairness between stations implementing CCAC and stations that do not implement it.

The present invention lies in the context of an area being densely occupied by WiFi stations. The present invention proposes a method of determining thresholds for improving spectrum reuse while guaranteeing fair access to the channel between stations regardless of whether they are of the same generation or of different generations.

According to the present invention, the method of using WiFi signal threshold values comprises the step consisting:
in making joint use of transmission power reduced by a first threshold value and of reception sensitivity threshold increased by a second threshold value in at least one WiFi station in a WiFi transmitter-and-receiver pair, with the sum of the threshold values being bounded by a determined value.

A WiFi transmitter-and-receiver pair is constituted by two stations that communicate via an ad hoc network or it is constituted by an access point and a client terminal associated therewith and communicating with the access point. The joint use thus relates to the communication channel between the transmitter and the receiver. Either the use is joint between the two stations, with the transmitter reducing its transmitted power by a first value and the receiver reducing its reception sensitivity by a second value. Or else the reduction in the transmitted power by a first value and the reduction in the reception sensitivity by a second value are performed jointly in the same station, which may be the transmitter or the receiver.

Increasing (CCAC) the reception sensitivity threshold CCA leads to reducing the area in which signals are detected around the station, i.e. to a reduction in reception sensitivity. And when a signal is detected in this detection area, the current transmission from the station is deferred. The reduction in the detection area around the station thus leads to an increase in the number of transmissions that may potentially take place simultaneously (reusing space) and coming from other stations in a given area that covers the detection area prior to being reduced or a portion of this area. Nevertheless, with “legacy” stations, opportunities for transmitting are reduced, because they detect a signal in their detection area more often, since they cannot increase their CCA thresholds. Reducing the transmit power jointly with increasing the CCA threshold in one of the stations of the pair thus gives the legacy stations in the given area under consideration more chance of accessing the channel, which legacy stations continue to transmit with maximum power. The method thus makes it possible to reestablish fairness between stations. This joint use thus makes it possible to increase the extent to which spectrum can be reutilized spatially.

A given zone is defined by a transmitter-and-receiver pair, by a plurality of access points and their associated stations, or by one or more of base service sets (BSSs). A base service set is made up of an access point together with the stations associated with the access point, i.e. the stations situated in the WiFi cell or coverage area of the access point. These stations are client terminals.

The term “client terminal” is used to mean any device suitable for communicating with a WiFi access point, such as a laptop computer, a personal digital assistant (PDA) type device, a smartphone, etc.

In a particular implementation, the method is such that the transmitter-and-receiver pair of WiFi stations belong to an area determined by a number of access points determining as many base service sets (BSS) as there are access points.

In a particular implementation, the method is such that the first value is associated with the second value by a multiplicative coefficient.

In a particular implementation, the method is such that the transmitter-and-receiver pair of WiFi stations is formed by an access point and by a client terminal associated with the access point.

In a particular implementation, the method is such that the first value for reducing the transmitted power is determined by the client terminal and is used by the access point, and the second value for increasing the reception sensitivity threshold is used by the client terminal.

In a particular implementation, the method is such that the first value for reducing transmitted power is determined by the access point and is used by the client terminal to reduce its transmit power, and the second value for increasing the reception sensitivity threshold is used by the client terminal.

In a particular implementation, the method is such that the access point defines a basic service set, the access point transmits a request to the stations of the basic service set so that they use the first value for reducing transmit power as determined by the access point.

In a particular implementation, the method is such that the first value for reducing transmitted power, and the second value for increasing the reception sensitivity threshold as determined by the client terminal are used by the client terminal.

In a particular implementation, the method further comprises the steps consisting in one of the WiFi stations of the transmitter-and-receiver pair determining a remaining margin for occupation of a WiFi communication channel of the pair on the basis of a power received over that channel, the determined value being equal to the remaining margin.

The remaining margin corresponds to the sum in dB of the modification to the CCA relative to the standard threshold plus the modification to the transmitted power relative to the standard power.

In a particular implementation, the method is such that the transmitter is an access point and the station is a client terminal, and the power received over the channel is calculated from the power of the beacon transmitted by the access point with which the station is associated.

In a particular implementation, the method is such that when the station is a client terminal, the power received over the channel is calculated from the transmission of data by the access point of the transmitter-and-receiver pair.

In a particular implementation, the method is such that when the station is an access point, the power received over the channel is calculated from the transmission of data from the client terminal of the transmitter-and-receiver pair.

Furthermore, the invention also provides a WiFi station of a base service set. The WiFi station comprises:
means for determining a remaining margin for occupation of a WiFi channel based on power received over the channel; and
means for making joint use of transmitted power being reduced by a first threshold value and of the reception sensitivity threshold being increased by a second threshold value such that the sum of the two threshold values is bounded by the remaining margin.

### LIST OF FIGURES

Other characteristics and advantages of the invention appear from the following description made with reference to the accompanying figures, which are given by way of non-limiting example.

FIG. 1 shows the TPC and CCAC mechanisms.

FIG. 2a plots data rate as a function of time for various transmission modes with and without TPC implementation.

FIG. 2b plots data rate as a function of time for various transmission modes with or without CCAC (=DSC) implementation.

FIG. 3a plots data rate as a function of time for various modes of transmission with or without TPC implementation for a mixture of legacy stations and of stations implementing TPC.

FIG. 3b plots data rate as a function of time for various transmission modes with or without CCAC (=DSC) implementation for a mixture of legacy stations and of stations implementing CCAC.

FIG. 4 represents a given area defined by a determined number of access points AP.

FIG. 5 is a diagram of an implementation of a method of the invention.

FIG. 6 is a diagram of an implementation of a method of the invention.

FIG. 7 is a diagram of an implementation of a method of the invention.

FIG. 8 is a simplified diagram of the structure of a WiFi station of the invention.

FIG. 9 is a diagram of the area under consideration during simulations with the distribution of the BSSs.

FIGS. 10a, 10b, and 10c are cumulative distribution function (CDF) curves showing data rate sharing on up links (ULs) and down links (DLs) coming either from legacy stations, or from stations that apply the method of the invention, and as obtained by simulation.

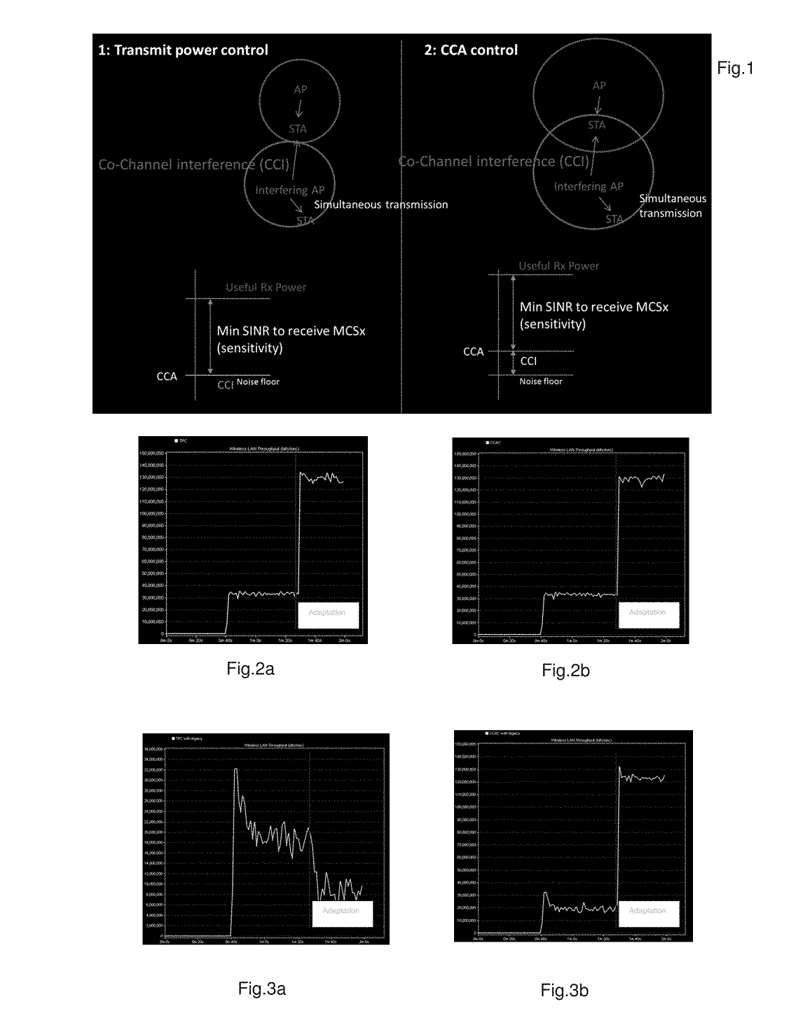

### DESCRIPTION OF AN IMPLEMENTATION OF THE INVENTION

A WiFi access point includes various settings including one that serves to identify a WiFi cell, which parameter is known to the person skilled in the art as a service set identifier (SSID). Each cell differs in its SSID and defines an access point in the meaning of the invention.

In operation, an access point regularly broadcasts a radio beacon frame to manifest its presence, with this frame being known to the person skilled in the art by the abbreviation “beacon”. This frame contains the SSID as set for the access point.

When a station seeks to set up a communication via a WiFi access point, it must begin in a first step by discovering such an access point. This discovery is performed either by passive listening while scanning the radio band in order to detect the presence of a beacon and thus of a nearby gateway with an access point, or else by making an active search by probing the channels of the radio band by transmitting a “probe request” frame. In the first situation, the station can subsequently transmit a “probe request” request that is addressed to the detected access point by using the SSID of that access point in order to obtain additional information that is not broadcast in the beacon. The access point SSID responds by a “probe response” frame indicating the transmission capabilities of the gateway, in particular its capabilities given the number of users already connected to the gateway. In the second situation, if the access point exists, it responds with a response probe frame.

In a second step, the station and the access point generally carry out mutual identification.

An association step is then necessary so that the station can send data via the access point, typically for a remote destination.

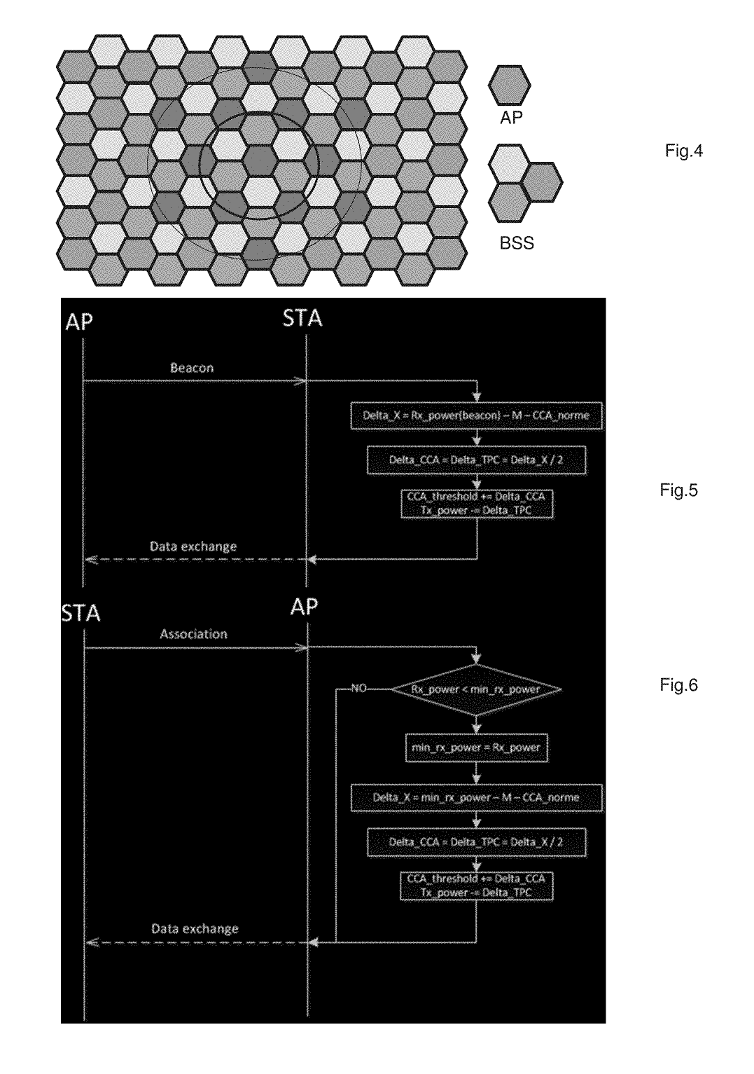

When the station is a client terminal, it is preferably already associated with an access point before performing the method of the invention. The station forms a transmitter-and-receiver pair associated with the access point. The station forms part of a BSS associated with the access point. This set forms part of the given area defined by a determined number of access points AP. This area is shown in FIG. 4. The determined number of access points may for example be the access points present in an auditorium, a stadium, etc.

In an implementation shown by the diagram of FIG. 5, the station calculates the remaining margin Delta_X for occupation of the WiFi channel, i.e. of the channel over which it is associated with the access point AP. The remaining margin is determined as being the difference between the power received by the station, Rx_power, minus a predefined margin M. By way of example, the power received may be determined with reference to the beacon frame received from the access point with which the station is associated. By way of example, the predefined margin M is specified by the standard in the form of a standardized threshold CCA_norme or in the form of an adjustable parameter M (e.g. 20 dB).

The reduction in transmitted power by a value delta-TPC, and the increase in the reception sensitivity threshold by a value delta_CCA, are implemented jointly within the pair comprising the access point and the station. This joint use complies with the constraint that the sum of the two values delta_TPC plus delta_CCA is bounded by the remaining margin.

In a particular implementation, the value delta_CCA is equal to the value delta_TPC multiplied by a factor. In a particular implementation, this factor is equal to one.

In a particular implementation, during every transmission to the access point with which it is associated, the station transmits at the standardized power reduced by delta_TPC. And during every reception, the station increases its reception sensitivity threshold by the value delta_CCA relative to the standardized threshold level (CCA) for reception sensitivity.

When the station is an access point, it may implement the method of the invention in a manner similar to the station. This particular implementation is shown in the diagram of FIG. 6. The difference in implementation lies in the way in which the received power level is determined. The access point determines the received power Rx_power, e.g. relative to a data frame or a control frame received from a station. Preferably, when a plurality of stations are associated with the same access point, it selects the weakest of the received powers from among the various stations associated therewith.

In a variant to the above-described implementations, the value delta_TPC determined by the client terminal station is used by the access point with which it is associated. And the value delta-CCA determined by the client terminal station is used by the client terminal. Thus, within the access point-and-station pair, the access point decreases its transmit power by the value delta_TPC, and jointly the client terminal increases its reception sensitivity threshold by the value delta_CCA.

In an implementation, after determining the value delta_TPC, the client terminal transmits a request to the access point in order to increase its transmit power by the value delta_TPC which it transmits thereto. When there are a plurality of client terminals associated with the access point, the access point adapts its transmitted power by using for each transmission the value delta_TPC of the receiving client terminal, or else it may select one value from among the values of delta_TPC that have been returned to it by the associated client terminal. The selection may consist in using the smallest value.

In the implementation shown in FIG. 7, the client terminal of a BSS determines the values delta CCA and delta_TPC and requests the access point to reduce its transmission power by delta_TPC by means of a control frame. The access point acknowledges the request depending on its capabilities. At its end, the access point can determine a value delta_TPC and request the client terminal to lower its transmit power by this value delta_TPC, which it transmits thereto by a control frame.

In an implementation, the method takes place in centralized manner. Under such circumstances, the access points of the area are connected to a controller and/or they exchange control frames among one another. A typical example of a centralized high-density network is, by way of example, a network in an auditorium or a stadium.

The access points APs situated in the given area are controlled by a central entity (controller) that carries out all kinds of configuration and administration of the managed network to which the APs belong. In such planned deployment, the controller can collect information from its APs about the states of the WiFi channels used by each AP, e.g. in an active (“probing”) manner.

This deployment scenario is close to cellular deployment: the selection of a WiFi channel and the placing of the APs are optimized in order to provide effective service to a certain number of users. In this type of scenario, the controller of the APs possesses information about the optimum parameters for using in order to achieve the maximum data rate per user.

An algorithm for optimizing threshold values can then be centralized or partially centralized at the controller, which communicates with and configures the various APs. With a centralized algorithm, the controller informs the APs of optimum threshold values for use at the APs together with optimum threshold values for transmitting to the stations STAs that are connected thereto.

The threshold values are determined using one of the above-described implementations. The controller or one of the access points can then determine optimum values for the thresholds by applying determined rules. One of the rules may consist in setting the second threshold value, delta_CCA, to a constant value.

In another implementation, the method takes place in decentralized manner at the initiative of each station in the area. Threshold values are determined using one of the above-described implementations. A typical example of a non-controlled high-density network is that to be encountered in a university residence and which is made up of the gateways of the students.

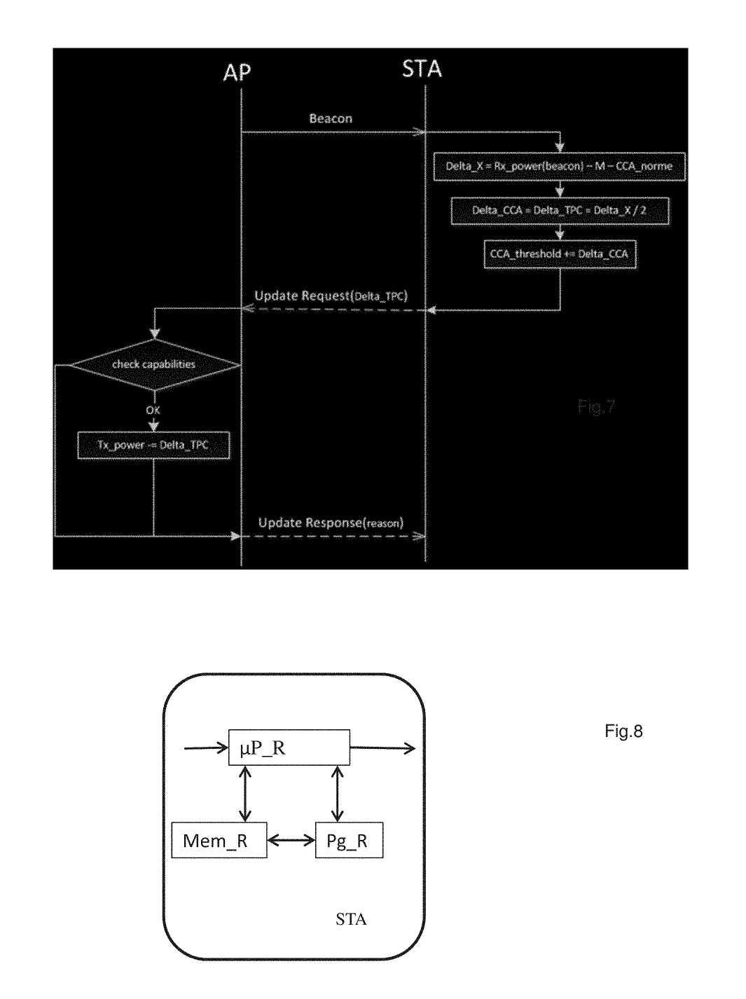

FIG. 8 shows the simplified structure of a station implementing a method of determining threshold values for WiFi signals using one of the implementations described above, which structure is described below.

Such a station STA comprises a memory Mem_R including a buffer memory, a processor unit μP_R, e.g. having a microprocessor controlled by a computer program Pg_R that performs a method of the invention for determining threshold values for WiFi signals.

On initialization, and by way of example, the instructions of the computer program code Pg_R may be loaded into a random access memory (RAM) prior to being executed by the processor of the processor unit μP_R. The processor unit μP_R receives as input signals transmitted over a WiFi channel. The microprocessor of the processor unit μP_R performs a method as described above for determining threshold values for WiFi signals in application of the instructions of the computer program Pg_R. To do this, the station calculates a remaining margin Delta_X for occupation of the WiFi channel based on a received power Rx_power in this channel and it has means for making joint use of reducing the transmitted power by a first threshold value delta_TPC and of increasing the reception sensitivity threshold by a second threshold value delta_CCA, with the sum of the two threshold values being bounded by the remaining margin. These means are controlled by the microprocessor and form part of the processor unit μP_R.

In a preferred implementation, the steps of the method of the invention for determining threshold values for WiFi signals are specified by the instructions of a program incorporated in an electronic circuit such as a chip, which may itself be arranged in an electronic device such as a client terminal and/or an access point. The method of the invention for determining threshold values for WiFi signals may equally well be implemented when this program (or its modules) is/are loaded into a computation member such as a processor or the equivalent that then operates under the control of the program being executed.

Consequently, the invention also provides a computer program (or its various modules), and in particular a computer program on or in a data medium, and suitable for implementing the invention. The program may use any programming language, and be in the form of source code, object code, or code intermediate between source code and object code such as in a form that is partially compiled, or in any other desirable form for implementing a method of the invention.

The data medium may be any entity or device capable of storing the program. For example, the medium may comprise storage means such as a read only memory (ROM), e.g. a compact disk (CD) ROM, or a microelectronic circuit ROM, or indeed it may comprise magnetic recording means, e.g. a floppy disk or a hard disk.

Alternatively, the data medium may be integrated circuit in which the program is incorporated, the circuit being adapted to execute or to be used in the execution of the method in question.

Furthermore, the program may be converted into a transmissible form such as an electrical or optical signal that can be conveyed via an electrical or optical cable, by radio, or by other means. In particular, the program of the invention may be downloaded from an Internet type network.

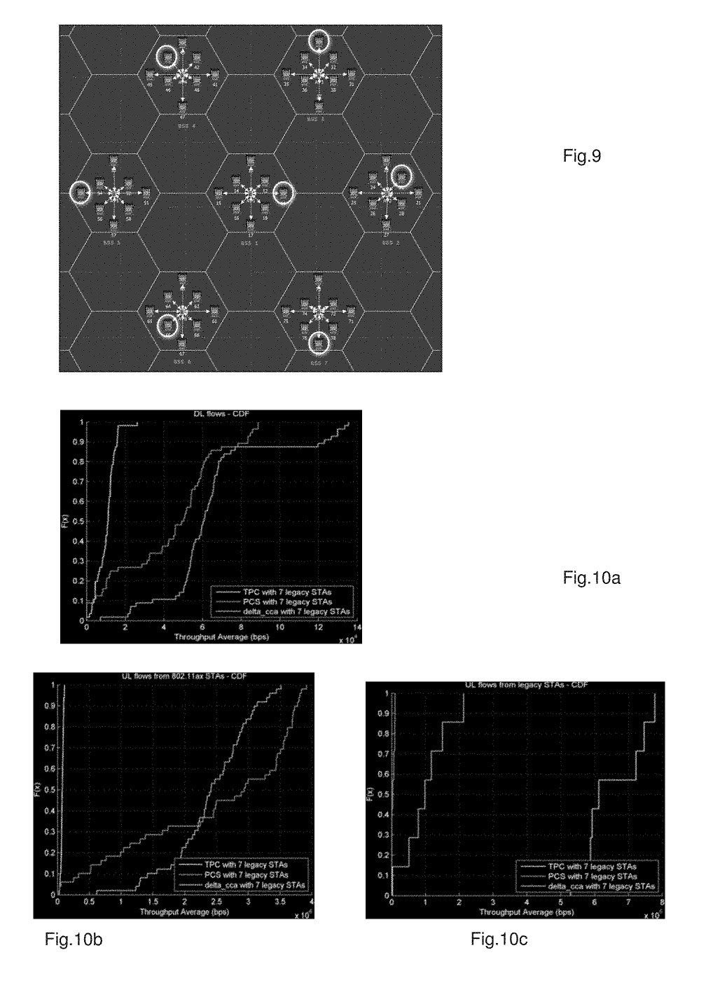

FIG. 9 is a diagram of the area under consideration during simulations with the distribution of the BSSs. The area has seven BSSs, each having eight stations (client terminals) and one access point. Among the eight stations associated with an access point, there is one station that is a legacy station. The settings used for the simulations undertaken with this topology were as follows: reutilization frequency=3; transmit power=15 dBm; up link (UL) data rate 4 megabits per second (Mbps) per station, down link (DL) data rate of 4 Mbps per station; and a margin M=20 dB. A remaining margin Delta_X=Delta_TPC+Delta_CCA. FIGS. 10a, 10b, and 10c show curves obtained by simulating data rate distributions (CDF) for the up link (UL) and for the down link (DL) either with legacy stations, or with stations applying the method of the invention.

### REFERENCE

[1] IEEE 802.11-2007, paragraph 9.1 “MAC architecture”, 9.1.1. “DCF”.

1. A method of using WiFi signal threshold values, the method comprising the step consisting:
in making joint use of transmission power reduced by a first threshold value (delta_TPC) and of reception sensitivity threshold (CCA) increased by a second threshold value (delta_CCA) in at least one WiFi station in a WiFi transmitter-and-receiver pair, with the sum of the threshold values (delta_TPC, delta_CCA) being bounded by a determined value.

2. A method of using WiFi signal threshold values according to claim 1, wherein the transmitter-and-receiver pair of WiFi stations belong to an area determined by a number of access points (AP) determining as many base service sets (BSS) as there are access points.

3. A method of using WiFi signal threshold values according to claim 1, wherein the first value (delta_TPC) is associated with the second value (delta_CCA) by a multiplicative coefficient.

4. A method of using WiFi signal threshold values according to claim 1, wherein the transmitter-and-receiver pair of WiFi stations is formed by an access point and by a client terminal associated with the access point.

5. A method of using WiFi signal threshold values according to claim 4, wherein the first value (delta_TPC) for reducing the transmitted power is determined by the client terminal and is used by the access point, and the second value (delta_CCA) for increasing the reception sensitivity threshold is used by the client terminal.

6. A method of using WiFi signal threshold values according to claim 4, wherein the first value (delta_TPC) for reducing transmitted power is determined by the access point and is used by the client terminal to reduce its transmit power, and the second value (delta_CCA) for increasing the reception sensitivity threshold is used by the client terminal.

7. A method of using WiFi signal threshold values according to claim 6, wherein the access point defines a basic service set (BSS), the access point transmits a request to the stations of the basic service set so that they use the first value (delta_TPC) for reducing transmit power as determined by the access point.

8. A method of using WiFi signal threshold values according to claim 4, wherein the first value (delta_TPC) for reducing transmitted power, and the second value (delta_CCA) for increasing the reception sensitivity threshold as determined by the client terminal are used by the client terminal.

9. A method of using WiFi signal threshold values according to claim 1, further comprising the steps consisting:
in one of the WiFi stations of the transmitter-and-receiver pair determining a remaining margin (Delta_X) for occupation of a WiFi communication channel of the pair on the basis of a power (Rx_power) received over that channel, the determined value being equal to the remaining margin.

10. A method of using WiFi signal threshold values according to claim 8, wherein the transmitter is an access point and the station is a client terminal, and the power (Rx_power) received over the channel is calculated from the power of the beacon transmitted by the access point with which the station is associated.

11. A method of using WiFi signal threshold values according to claim 8, wherein, when the station is a client terminal, the power (Rx_power) received over the channel is calculated from the transmission of data by the access point of the transmitter-and-receiver pair.

12. A method of using WiFi signal threshold values according to claim 8, wherein, when the station is an access point (AP), the power (Rx_power) received over the channel is calculated from the transmission of data from the client terminal of the transmitter-and-receiver pair.

13. A WiFi station of a base service set (BSS), the station comprising:
means for determining a remaining margin (Delta_X) for occupation of a WiFi channel based on power (Rx_power) received over the channel; and
the station being characterized in that it further comprises:
means for making joint use of transmitted power being reduced by a first threshold value (delta_TPC) and of the reception sensitivity threshold being increased by a second threshold value (delta_CCA) such that the sum of the two threshold values (delta_TPC, delta_CCA) is bounded by the remaining margin.
